(19) United States
(12) Patent Application Publication
(10) Pub. No.: US 2025/0086522 A1
(43) Pub. Date: Mar. 13, 2025

(54) LEARNABLE DEGREES OF EQUIVARIANCE FOR MACHINE LEARNING MODELS

(71) Applicant: Qualcomm Technologies, Inc., San Diego, CA (US)

(72) Inventors: Lars VEEFKIND, Amsterdam (NL); Gabriele CESA, Diemen (NL)

(21) Appl. No.: 18/462,914

(22) Filed: Sep. 7, 2023

(51) Int. Cl. G06N 20/20

(52) U.S. Cl. CPC G06N 20/20

(57) ABSTRACT

Certain aspects of the present disclosure provide techniques and apparatus for improved machine learning. A set of training data is accessed, and a transformation group comprising a plurality of group elements is determined. A set of unconstrained weights for a layer of the machine learning model is generated based on the set of training data. A set of parameter values for a likelihood function for the layer is generated based on the set of training data. A set of constrained weights is generated, based at least in part on the likelihood function and the set of unconstrained weights, such that the set of constrained weights is equivariant with respect to at least a subset of the plurality of group elements.

### INTRODUCTION

Aspects of the present disclosure relate to machine learning.

A wide variety of machine learning model architectures have proliferated and have been used to provide solutions for a multitude of prediction problems. For example, convolutional neural networks (CNNs) have been used in recent years to process images in order to perform a variety of tasks, such as object recognition, image classification, and the like. A wide variety of common model inputs, such as images and other representations of natural (e.g., real) objects and structures (e.g., image data, point cloud data, and the like), often exhibit geometrical symmetries of various types, such as rotational symmetry and reflective symmetry. Some conventional machine learning models (e.g., CNNs) exhibit or enable translation symmetry, where an input feature (e.g., a depiction of a flower) may be translated or located in any region of the input image without affecting the model output. That is, some conventional models are able to accurately identify the flower, regardless of whether the flower is depicted in the center of the image, the left side of the image, the right side of the image, and the like. However, some conventional models fail to exhibit other more complex symmetries, such as rotational or reflective symmetries. As a result, applying such symmetries to the input of some conventional models leads to unpredictable differences in the output.

In some conventional systems, data augmentation can be used to add transformed versions of the original data samples to the training set (e.g., rotating the images randomly). However, these augmentation-based approaches involve explicit learning by the model and substantially increase the size of the training dataset, as well as substantially increasing the computational cost of training the model.

### BRIEF SUMMARY

Certain aspects provide a method, comprising: accessing a set of training data; determining a transformation group comprising a plurality of group elements; generating, based on the set of training data, a first set of unconstrained weights for a first layer of a machine learning model; generating, based on the set of training data, a first set of parameter values for a first likelihood function for the first layer; and generating a first set of constrained weights, based at least in part on the first likelihood function and the first set of unconstrained weights, such that the first set of constrained weights is equivariant with respect to at least a first subset of the plurality of group elements.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example workflow for training selectively equivariant machine learning models.

FIG. 2 illustrates an example architecture for selectively equivariant machine learning.

FIG. 3 depicts graphs of selective equivariance across group elements for a machine learning model.

FIG. 4 is a flow diagram depicting an example method for training and

deploying selectively equivariant machine learning models.

FIG. 5 is a flow diagram depicting an example method for generating weights for a selectively equivariant machine learning model.

FIG. 6 is a flow diagram depicting an example method for training a selectively equivariant machine learning model.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for selectively equivariant machine learning models.

As discussed below in more detail, a model (or component of a model, such as a layer) is said to be equivariant with respect to a given transformation (e.g., a group element) if applying the transformation and then processing the transformed input using the model component produces the same result as processing the input with the model component and then applying the transformation to the output. That is, a model component or function (e.g., a layer) f is equivariant with respect to transformation g if g*f(x)=f(g*x), where x represents input data to the model component (e.g., an image or feature map).

Group CNNs (G-CNNs) and steerable neural networks (S-NNs) have been introduced and researched in recent years to enable or support equivariance. Such models ensure that each layer is equivariant to a chosen set of transformation group(s). However, in conventional systems, these groups are manually predetermined or predefined for each layer. Unfortunately, these predetermined approaches are often infeasible, as such approaches typically demand a deep knowledge of the given dataset. For example, to select which equivariances the model should exhibit means the data scientist should generally understand which symmetries exist at each layer. However, this knowledge is often unavailable, such as due to inexperience with the specific data, or simply due to the relevant symmetries being entirely unknown. Furthermore, some conventional implementations enforce the same degree of equivariance for each channel in a particular layer, even though different features in the same receptive field may call for different degrees of equivariance to different subgroups.

In some aspects of the present disclosure, techniques are described to enable the machine learning model to learn a degree of equivariance with respect to any given group elements using gradient descent during training. In aspects of the present disclosure, the model can learn to relax the constraints enforcing equivariance for a subset of transformations, enabling the model to learn the key or relevant symmetries more effectively. In some aspects, that is, the system is able to learn separate degrees of equivariance for each block, layer, channel, or other logical component of the model.

In some aspects, the parameters (e.g., weights) of the model can be constrained during and/or after training or fine-tuning, enforcing selective equivariance based on the applied constraints. In some aspects, the constraint uses a parameterized likelihood function to define the degree of equivariance with respect to each group element in a transformation group, allowing each portion of the model to learn a respective degree of equivariance with respect to each group element.

As used herein, a machine learning model (or portion thereof, such as a layer of a model) may be referred to as “selectively equivariant” to indicate that the model (or portion thereof) uses learned parameters to determine the degree of equivariance with respect to one or more transformations. That is, while conventional approaches rely on a data scientist or other user manually defining equivariance, aspects of the present disclosure enable the model itself to learn the equivariances. Additionally, as used herein, the model may learn non-binary equivariance with respect to any given transformation. That is, rather than being entirely equivariant or entirely non-equivariant to a given translation, the model may learn a degree of equivariance between these extrema, as discussed in more detail below.

### Example Workflow for Training Selectively Equivariant Machine Learning Models

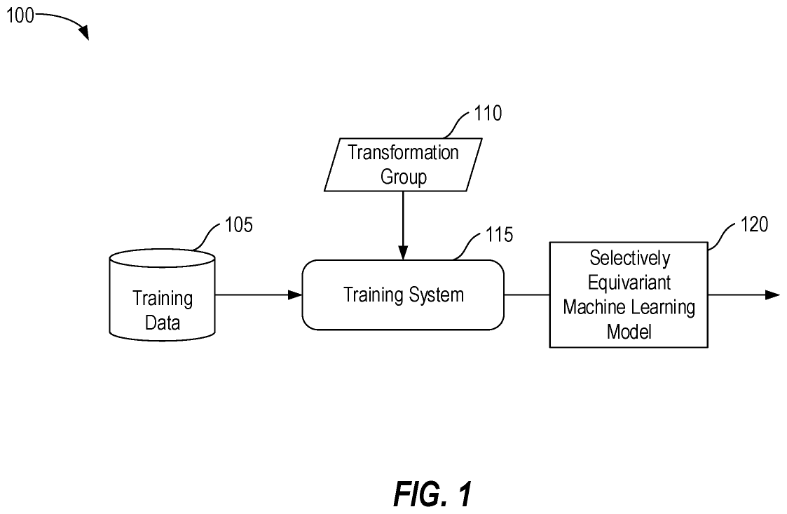

FIG. 1 illustrates an example workflow 100 for training selectively equivariant machine learning models.

In the illustrated example, a set of training data 105 is accessed by a training system 115 to generate or train a selectively equivariant machine learning model 120. As used herein, “accessing” data can generally include receiving, requesting, retrieving, generating, collecting, or otherwise obtaining access to the data. Generally, the training data 105 may comprise any number of exemplars (also referred to as training records in some aspects), each exemplar containing any suitable information depending on the particular implementation. For example, for object identification tasks (e.g., in images), the training data 105 may include a set of images where each image is associated with a label indicating the object(s) depicted in the image, the location(s) of the object(s), and the like.

In the illustrated example, the training system 115 further accesses or determines a transformation group 110. The transformation group 110 generally corresponds to a set of transformations (also referred to as groups or group elements) that can be applied to input exemplars in the training data 105 while preserving the inherent structure of the input. For example, in some aspects, the group elements correspond to rotations of various degrees and/or reflections across various axes. In some aspects, the transformation group 110 may be designated as G.

In the illustrated example, the transformation group 110 may correspond to a broad or large transformation group that contains or indicates the transformations that may be applied to model input. Stated differently, the selectively equivariant machine learning model 120 should be potentially equivariant to each of the group elements in the transformation group 110. In aspects, however, the actual symmetries of the training data 105 (and the real-world data used as input during inferencing) may differ. That is, if the transformation group 110 is defined as G, the training data 105 may be symmetric with respect to group H (which may be a subset of G, or may be a superset of G). For example, the transformation group 110 may comprise a set of continuous rotations (e.g., rotations by continuous values) around multiple axes and/or reflections across multiple axes, while the input training data 105 may be symmetric for a subset of these rotations (e.g., only for one or two axes, only for discrete angles such as in 90 degree intervals, and the like) and/or for a subset of the reflections (e.g., only across one axis).

As discussed above, when the training data 105 is symmetric for only a subset of the group elements in the transformation group 110, the training system 115 may train a selectively equivariant machine learning model 120 that is equivariant only (or primarily) for this subset, while the model may be non-equivariant (or exhibit substantially reduced equivariance) to group elements for which the training data 105 is not symmetric. Advantageously, using aspects of the present disclosure, these symmetries and equivariances are learned during training, and need not be specified or defined by the user (e.g., data scientist).

For example, during training, the selectively equivariant machine learning model 120 may learn to be largely or substantially equivariant with respect to reflections across the vertical axis in the input images, while being largely or substantially non-equivariant with respect to reflections across the horizontal axis (e.g., where the objects of interest are largely symmetric across the vertical axis but are non-symmetric across the horizontal axis). One example of such objects is the human body, which appears largely symmetric with respect to the left and right sides but is largely asymmetric with respect to the upper and lower halves. However, though the human body is one example of an object that has clear symmetry only for a specific subset of transformations, the symmetries present in real data of interest (e.g., light detecting and ranging (LIDAR) data, radar data, medical imaging data, and the like) for a wide variety of common tasks are generally much less clear.

By allowing the model to learn these symmetries during training based on training data 105 (e.g., to learn a group H & G), the training system 115 can generate a substantially improved selectively equivariant machine learning model 120 that is able to generate more accurate outputs, as compared to conventional systems. For example, some conventional approaches enable fully equivariant models, which fail to realize that the input data is often not fully symmetric. Similarly, some conventional approaches rely on the expertise of data scientists to define the model equivariance or symmetries, which is inherently error-prone and inaccurate (and, in some cases, unknowable). The training system 115 can thereby improve the model performance substantially.

Generally, the particular operations used by the training system 115 to train the selectively equivariant machine learning model 120 may vary depending on the particular architecture and implementation. In some aspects, the training system 115 may learn or generated updated values for one or more model parameters (e.g., weights of a neural network), and then constrain the updated values based on one or more equivariance constraints, as discussed below, where the constraints themselves are learnable.

For example, if the selectively equivariant machine learning model 120 is a convolutional neural network, the training system 115 may process the input portion of a given exemplar in the training data 105 to generate an output. This may be referred to as the forward pass. The model output can then be compared against a label portion of the given exemplar to generate a loss, which may then be used to update the parameter(s) of the model (e.g., kernel weights, fully connected layer weights, and/or equivariance constraint parameters) via backpropagation. This may be referred to as the backward pass. Generally, these forward and backward passes may be performed independently for each exemplar (e.g., using stochastic gradient descent) and/or may be performed for batches of exemplars (e.g., combining losses for multiple exemplars to perform one backward pass using batch gradient descent).

In some aspects, after the weights have been updated, the training system 115 applies the constraint(s) to enforce equivariance on the model. In aspects, the constraints may generally be used at any stage or after any model update. For example, the training system 115 may constrain the weights each time the weights are updated (e.g., after each backward pass), at the end of each training iteration or epoch, at the end of training itself, and the like.

In some aspects, the constraint used to enforce learned equivariance may be referred to as a steerability constraint. For example, in some aspects, the steerability constraint for a linear (e.g., fully connected) layer of a model may be defined using Equation 1 below, where W is the learned weights of the layer, g is an element of transformation group G (e.g., the transformation group 110), ρₒᵤₜ(g) is the output representation of the group element g, and ρᵢₙ(g) is the input representation of the group element g. In some aspects, the input representation is a matrix which, given a group element g, yield a matrix which performs the action of g on the input features of a given layer or block in the model. Each layer generally provides a mapping between feature fields (e.g., between the input representation and the output representation), where the feature field received as input to a layer transforms according to the input representation ρᵢₙ and the output transforms according to the output representation ρₒᵤₜ. More specifically, in some aspects, ρₒᵤₜ(g) is a cₒᵤₜ×cₒᵤₜ matrix (where cₒᵤₜ is the dimensionality of the output features for the layer) and ρᵢₙ(g) is a cᵢₙ×cᵢₙ matrix (where cᵢₙ is the dimensionality of the input features). In some aspects, Equation 1 holds for all group elements g in G.

$$W = {ρ}_{out} ( g ) W {{ρ}_{i n} ( g )}^{T} \qquad ( 1 )$$

In some aspects, as the constraint detailed in Equation 1 is a linear constraint, the constraint can be solved via projection according to Equation 2 below, where Ŵ is the unconstrained weights (e.g., the updated weights prior to applying the constraint) and ξ_{G} is a projection function dependent on the group G.

$$W = {ξ}_{G} ( \hat{W} ) = {\int }_{g ∈ G} {ρ}_{out} ( g ) \hat{W} {{ρ}_{i n} ( g )}^{T} d g \qquad ( 2 )$$

In some aspects, a likelihood distribution μ(g) (also referred to as a likelihood function in some aspects) can be included in Equation 2 (as depicted in Equation 3 below). If the likelihood distribution is uniform (e.g., where μ(g)=1 for all g in G), the steerability constraint is unchanged (e.g., because multiplying by 1 does not change the value), and the weights will be constrained to be equivariant for all g in G.

$$W = {ξ}_{G} ( \hat{W} ) = {\int }_{g ∈ G} μ ( g ) {ρ}_{out} ( g ) \hat{W} {{ρ}_{i n} ( g )}^{T} d g \qquad ( 3 )$$

In some aspects of the present disclosure, to enable learned equivariance, the likelihood function may be parameterized. That is, the likelihood distribution μ(g) in Equation 3 may be replaced with a non-uniform distribution μ′(g), as in Equation 4 below. In some aspects, the likelihood distribution μ′(g) may be initialized as a uniform distribution (e.g., where μ′(g)=1 for all g in G). That is, the initial parameters of the likelihood function μ′(g) may be set such that the likelihood function forms a uniform distribution. During training (based on training data 105), this distribution may change. Other parameters of the model (e.g., the unconstrained weights W) may be initialized using other approaches, such as using random values. In Equation 4, the projection ξ_{G} (indicating a projection over group G, where each element is equally weighted which results in a G-equivariant operation) is replaced with projection ξ_{μ′}. While ξμ′ still performs a projection over G, the elements may not be equally weighted. In this way, the projection ξμ′ may be referred to as a projection over the learned likelihood function μ′.

$$W = {ξ}_{{μ}^{′}} ( \hat{W} ) = {\int }_{g ∈ G} {μ}^{′} ( g ) {ρ}_{out} ( g ) \hat{W} {{ρ}_{i n} ( g )}^{T} d g \qquad ( 4 )$$

In some aspects, the projection defined in Equation 4 may be vectorized (e.g., using the Kronecker product ⊗ and the property that vec(ABC)=(C^{T}⊗A)vec(B)) to yield Equation 5 below.

$$vec ( W ) = {\int }_{g ∈ G} {μ}^{′} ( g ) ( {ρ}_{i n} ( g ) ⊗ {ρ}_{out} ( g ) ) vec ( \hat{W} ) d g \qquad ( 5 )$$

Then, through Clebsch-Gordan decomposition, the tensor product in Equation 5 ((ρᵢₙ(g)⊗ρₒᵤₜ(g))) can be decomposed into Q(⊕_{ψ∈Ψ}ψ(g))Q^{T}, where Q is the change of basis. In some aspects, the change of basis Q is a matrix that can be found numerically. This change of basis Q expresses the matrix ρᵢₙ(g)⊗ρₒᵤₜ(g) in a basis such that it takes a block-diagonal form (e.g., the direct sum ⊕_{ψ∈Ψ}ψ(g)). Additionally, in Equation 6, Ψ is a subset of the set Ĝ of all irreducible representations (irreps) in G. In particular, Ψ is the subset of irreps ψ appearing in the tensor product (ρᵢₙ(g)⊗ρₒᵤₜ(g)). This decomposition yields Equation 6, below.

$$vec ( W ) = {\int }_{g ∈ G} {μ}^{′} ( g ) ( Q ( {⊕}_{ψ ∈ Ψ} ψ ( g ) ) {Q}^{T} ) vec ( \hat{W} ) d g \qquad ( 6 )$$

In some aspects, the Fourier transform of μ′ may be defined using Equation 7 below, where \hat{μ}′(ψ)∈ [symbol] ^{d}^{_{ψ}}^{×d}^{_{ψ}} and d_{ψ} is the dimensionality of irrep ψ.

$$\hat{{μ}^{′}} ( ψ ) = \sqrt{{d}_{ψ}} {\int }_{g ∈ G} {μ}^{′} ( g ) ψ ( g ) d g \qquad ( 7 )$$

In some aspects, because the change of basis Q and the unconstrained weight matrix Ŵ do not depend on g (and using the Fourier transform defined in Equation 7), Equation 6 can be rewritten as Equation 8 below.

$$vec ( W ) = vec ( {ξ}_{{μ}^{′}} ( \hat{W} ) ) = Q ( {⊕}_{ψ ∈ Ψ} \frac{\hat{{μ}^{′}} ( ψ )}{\sqrt{{d}_{ψ}}} ) {Q}^{T} vec ( \hat{W} ) \qquad ( 8 )$$

In this way, for a fully connected layer (e.g., a linear layer, a layer of a multilayer perceptron (MLP), and the like), the likelihood function over the group G is parameterized in terms of its Fourier series coefficients \hat{μ}′(ψ) and irreps. Therefore, in some aspects, the Fourier series coefficients A (w) may be stored as learnable parameters that are updated using backpropagation while training the model. After updating the unconstrained weights W and likelihood parameters \hat{μ}′(ψ) for the fully connected layer based on one or more exemplars in the training data 105, the training system 115 may use Equation 8 to constrain the updated weights. These constrained weights are therefore selectively or partially equivariant, where equivariance is defined based on the value of the likelihood function for each group element g. That is, the fully connected layer exhibits selective or partial equivariance, where the degree of equivariance for each group element g is defined by the value of the likelihood function for element g.

In some aspects, the learned equivariance or steerability constraint of a convolutional layer (e.g., a layer which uses one or more convolution kernels to process input feature maps) can be similarly derived. For example, in some aspects, the steerability constraint for a convolutional layer of a model may be defined using Equation 9 below, where K: [symbol] ⁿ→ [symbol] ^{c}^{ₒᵤₜ}^{×c}^{ᵢₙ} is the convolution kernel which associates to each point x∈ [symbol] ⁿ a matrix in [symbol] ^{c}^{ₒᵤₜ}^{×c}^{ᵢₙ}, g is an element of transformation group G (e.g., the transformation group 110), ρₒᵤₜ(g) is the output representation of the group element g (e.g., specifying how the output channels transform when the base space [symbol] ⁿ transforms under the group element g), and ρᵢₙ(g) is the input representation of the group element g (e.g., specifying how the input channels transform when the base space [symbol] ⁿ transforms under the group element g). In some aspects, Equation 9 holds for all group elements g in G.

K(x)=ρₒᵤₜ(g)K(g⁻¹x)ρᵢₙ(g)^{T} (9)

As discussed above with reference to Equation 1, in some aspects, the kernel constraint detailed in Equation 9 is a linear constraint, and the constraint can be solved via projection according to Equation 10 below, where \hat{K} is the unconstrained kernel (e.g., the updated weights of the kernel prior to applying the constraint), Π_{μ′} is a projection function, and μ′(g) is a parameterized (e.g., non-uniform) likelihood function, as discussed above.

$$K ( x ) = {Π}_{μ ′} ( \hat{K} ) ( x ) = {\int }_{g ∈ G} {μ}^{′} ( g ) {ρ}_{out} ( g ) \hat{K} ( {g}^{- 1} x ) {{ρ}_{i n} ( g )}^{T} d g \qquad ( 10 )$$

In some aspects, by vectorizing Equation 10 (and assuming irreps ψᵢ and ψⱼ), Equation 11 may be derived.

$$vec ( K ( x ) ) = {\int }_{g ∈ G} {μ}^{′} ( g ) ( {ψ}_{l} ( g ) ⊗ {ψ}_{J} ( g ) ) vec ( \hat{K} ( {g}^{- 1} x ) ) d g \qquad ( 11 )$$

In some aspects, the kernel vec (K(x)) is defined using a G-steerable basis {Y_{ψ}ⁱ}_{ψ,i} and weights W_{j′i} for irrep ψ_{j′} and some index i. That is, the kernel may be defined as vec(\hat{K}(x))=Σ_{j′,i} W_{j′i}Y_{j′}ⁱ(x). In some aspects, therefore because Y_{j′}ⁱ(g⁻¹x)=ψ_{j′}(g)^{T}Y_{j′}ⁱ(x), Equation 11 may be rewritten as Equation 12 below.

$$vec ( K ( x ) ) = {\sum }_{{j}^{′} , i} [ {\int }_{g} {μ}^{′} ( g ) ( {ψ}_{l} ( g ) ⊗ {ψ}_{J} ( g ) ) {W}_{{j}^{′} i} {{ψ}_{{j}^{′}} ( g )}^{T} dg ] {Y}_{{j}^{′}}^{i} ( x ) \qquad ( 12 )$$

As discussed above, the tensor product can be decomposed according to Equation 13 below.

$$( {ψ}_{l} ( g ) ⊗ {ψ}_{J} ( g ) ) {W}_{{j}^{′} , i} {{ψ}_{{j}^{′}} ( g )}^{T} = {{\sum }_{j , s} [ {C}_{s}^{j ( Jl )} ]}^{T} {ψ}_{j} ( g ) {C}_{s}^{j ( Jl )} {W}_{{j}^{′} i} {{ψ}_{{j}^{′}} ( g )}^{T} \qquad ( 13 )$$

By inserting this decomposition from Equation 13 into Equation 12, Equation 14 can be formed, where W_{j′,j,i,s}=vec(Cₛ^{j(ji)}W_{j′i}), and the unvec function is the opposite operation of vectorization function vec.

$$v e c ( K ( x ) ) = {\sum }_{{j}^{′} , i} {{\sum }_{j , s} [ {C}_{s}^{j ( jl )} ]}^{T} unvec [ {\int }_{g} {μ}^{′} ( g ) ( {ψ}_{{j}^{′}} ( g ) ⊗ {ψ}_{j} ( g ) ) {W}_{{j}^{′} , j , i , s} dg ] {Y}_{{j}^{′}}^{i} ( x ) \qquad ( 14 )$$

In some aspects, the integral in Equation 14 (∫_{g}μ′(g)(ψ_{j′}(g)⊗ψⱼ(g))W_{j′,j,i,s}dg) results in a matrix c_{jj′}=\hat{μ}′(ψ_{j′}(g)⊗ψⱼ(g)=∫_{g}μ′(g)(ψ_{j′}(g)⊗ψⱼ(g)W_{j′,j,i,s}dg. That is, the matrix c_{jj′} does not contain W_{j′,j,i,s}. In some aspects, the multiplication between c_{jj′} and W_{j′,j,i,s} is a special case of Equation 5, which can be solved as given in Equation 8. Equation 8 (applied to this special case) is then c_{jj′}W_{j′,j,i,s}, where

$${c}_{j {j}^{′}} = Q ( {⊕}_{ψ ∈ Ψ} \frac{\hat{{μ}^{′}} ( ψ )}{\sqrt{{d}_{ψ}}} ) {Q}^{T} .$$

In this way, for a convolution layer (e.g., a layer that convolves input feature maps using learned kernels), the likelihood function over the group G is parameterized in terms of its Fourier series coefficients \hat{μ}′(ψ) and irreps. Therefore, in some aspects, the Fourier series coefficients \hat{μ}′(ψ) may be stored as learnable parameters that are updated using backpropagation while training the model. After updating the unconstrained kernel and likelihood parameters \hat{μ}′(ψ) for the convolution layer based on one or more exemplars in the training data 105, the training system 115 may use Equation 14 to constrain the updated kernel. The constrained kernel is therefore selectively or partially equivariant, where equivariance is defined based on the value of the likelihood function μ′ for each group element g. That is, the convolution layer exhibits selective or partial equivariance, where the degree of equivariance for each group element g is defined by the value of the likelihood function for element g.

In some aspects, therefore, the training system 115 may update the parameter(s) of the machine learning model and then use Equation 8 and/or Equation 14 to constrain the updated parameters, causing the updated parameters to exhibit selective or partial equivariance. In some aspects, a respective likelihood function (using a respective set of likelihood parameters) is learned for each respective layer of the mode. That is, the selective equivariance exhibited by each layer may differ from the other layer(s). In other aspects, the training system 115 may share a single likelihood function (and set of likelihood parameters) across multiple layers.

In some aspects, if the training data 105 is fully symmetric with respect to the transformation group 110, the likelihood functions used to define equivariance in each layer will generally remain uniform (or nearly uniform), and the resulting selectively equivariant machine learning model 120 is thereby equivariant (or nearly equivariant) with respect to the transformation group 110. This allows the selectively equivariant machine learning model 120 to exhibit comparable accuracy, as compared to conventional steerable models. If the task reflected by the training data 105 has fewer symmetries (less than the entire transformation group 110), however, the likelihood functions will adapt to this reduced symmetry, and the selectively equivariant machine learning model 120 can exhibit substantially improved accuracy as compared to conventional steerable models, as well as conventional non-steerable models.

As a result of this process, the selectively equivariant machine learning model 120 is trained. After training, the selectively equivariant machine learning model 120 may be deployed for inferencing. In some aspects, the training system 115 deploys the selectively equivariant machine learning model 120 to one or more other systems (e.g., dedicated inferencing systems) for runtime use. In some aspects, the training system 115 may itself deploy and use the selectively equivariant machine learning model 120 locally.

### Example Architecture for Selectively Equivariant Machine Learning

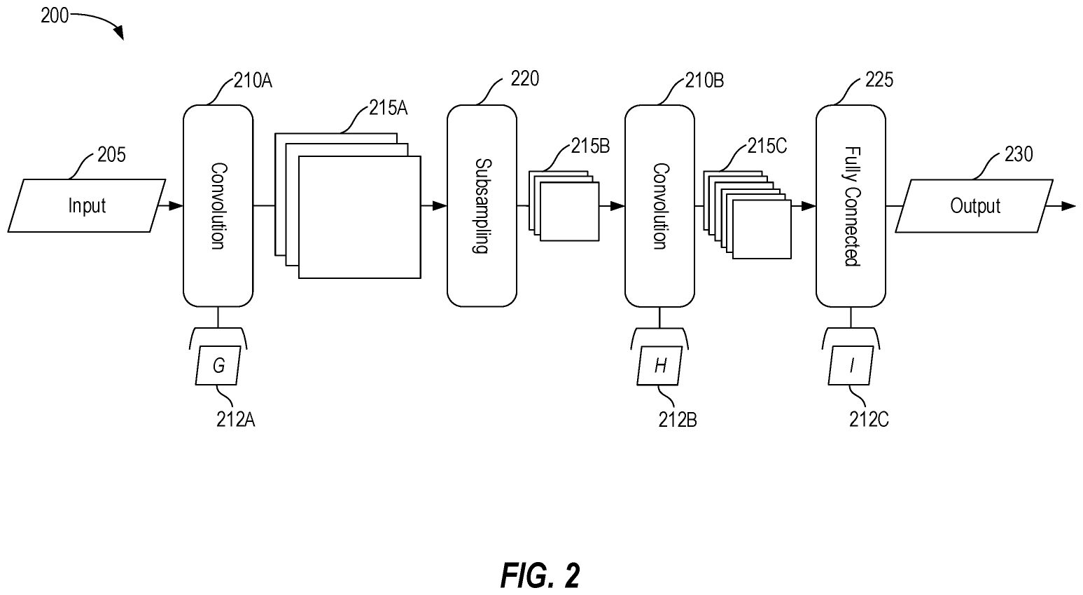

FIG. 2 illustrates an example architecture 200 for selectively equivariant machine learning. In some aspects, the architecture 200 corresponds to a selectively equivariant machine learning model, such as the selectively equivariant machine learning model 120 of FIG. 1. In some aspects, the architecture 200 can be trained and/or used for inferencing by a computing system, such as the training system 115 of FIG. 1.

In the illustrated example, the architecture 200 is partially or selectively equivariant based on one or more likelihood functions 212A, 212B, and 212C (collectively, the likelihood functions 212). Specifically, the convolution layer 210A is partially equivariant based on the likelihood function 212A (e.g., partially equivariant with respect to a transformation group G), the convolution layer 210B is partially equivariant based on the likelihood function 212B (e.g., partially equivariant with respect to a transformation group H), and the fully connected layer 225 is partially equivariant based on the likelihood function 212C (e.g., partially equivariant with respect to a transformation group/). As discussed above, in some aspects, the likelihood functions 212 may be parameterized or defined using learnable parameters (e.g., Fourier series coefficients).

As illustrated, the architecture 200 receives input 205 and processes the input 205 using the first convolution layer 210A (which has kernel(s) that were constrained, during training, based on the likelihood function 212A) to generate a set of feature maps 215A. The feature maps 215A are then processed by a subsampling operation 220, which yields a set of feature maps 215B. In some aspects, the subsampling operation 220 may alternatively be referred to as a pooling operation. The subsampling operation 220 is generally used to reduce the size of the feature maps 215A, increasing the receptive field of subsequent convolution operations.

In some aspects, for example, iterative convolution and subsampling operations may be used such that each subsequent convolution operation acts on a larger portion of the input with each application of the kernel. For example, in the first convolution layer 210A, the kernel may be one sixteenth of the size of the input 205, such that each application of the kernel covers a relatively small portion of the input. If the subsampling 220 downsizes the feature maps 215A by half, the kernel of the convolution layer 210B may cover one eighth of the input feature map 215B, thereby covering a relatively larger portion of the image. In some aspects, by allowing each layer to learn its own likelihood function 212, the training system enables the architecture 200 to learn which symmetries are applicable or relevant at each scale of the input. Although two convolution layers 210 and a single subsampling operation 220 are depicted for conceptual clarity, in aspects, there may be any number of convolution layers 210 and subsampling operations 220 in the model.

In the illustrated example, the convolution layer 210B (using kernels constrained based on likelihood function 212B) process the feature maps 215B to generate feature maps 215C. These feature maps 215C are then processed using a fully connected layer 225 (using weights constrained based on the likelihood function 212C) to generate the output 230 of the model.

As discussed above, in some aspects, each layer of the architecture 200 may be selectively equivariant based on a corresponding likelihood function. For example, the convolution layer 210A may be made selectively equivariant using Equation 14 above (using a first set of learned parameters for the likelihood function 212A), the convolution layer 210B may be made selectively equivariant using Equation 14 above (using a second set of learned parameters for the likelihood function 212B), and the fully connected layer 225 may be made selectively equivariant using Equation 8 above (using a third set of learned parameters for the likelihood function 212C).

In some aspects, once a given layer disrupts equivariance for a given group element, it is difficult or impossible to restore equivariance with respect to the group element in any subsequent layer. For example, if the likelihood function 212A defines a reduced or eliminated equivariance with respect to a group element g, the subsequent convolution layer 210B and fully connected layer 225 may be unable to exhibit equivariance with respect to the group element g (e.g., because the feature maps 215A generated by the convolution layer 210A may not exhibit symmetry with respect to the group element g, regardless of whether the input 205 exhibited such symmetry).

In some aspects, therefore, a divergence loss is defined between adjacent likelihood functions 212 (e.g., likelihood functions 212 in adjacent layers of the model) to encourage each layer to align to its prior layer (e.g., discouraging the layer from disrupting equivariance with respect to a given group element unless sufficient value or accuracy is gained by abandoning the equivariance). For example, Kullback-Leibler (KL) divergence, which is a distance metric between probability functions, may be used. In some aspects, KL divergence is directional (e.g., KL(p₁, p₂)≠KL(p₂, p₁)). In some aspects, therefore, by computing the KL divergence of the likelihood distribution of layer n with respect to the prior layer n−1 (and backpropagating through the resulting error), the training system can apply a soft constraint that the distribution of layer n should be a subset of the distribution of layer n−1. Such divergence loss between adjacent layers may enhance interpretability of the model, even if the divergence loss has little (or no) effect on prediction accuracy in some aspects.

That is, the training system may compute the KL divergence between the likelihood function 212A and the likelihood function 212B, and use this loss to update the parameters of the likelihood function 212B. Similarly, the training system may compute the KL divergence between the likelihood function 212B and the likelihood function 212C, and use this loss to update the parameters of the likelihood function 212C.

In this way, if the learned transformation subgroup for a given layer n is defined as Gₙ, the use of divergence loss between likelihood functions can push the distributions such that G₀≤G₁≤ . . . ≤Gₙ₋₁, therefore gradually decreasing the equivariance throughout the network. That is, the equivariance of the fully connected layer 225 may be a subset of the equivariance exhibited by the convolution layer 210B, and the equivariance of the convolution layer 210B may be a subset of the equivariance exhibited by the convolution layer 210A. For example, the convolution layer 210A may be equivariant with respect to reflections and continuous rotations, the convolution layer 210B may be equivariant with respect to reflections and rotations by 90 degrees (e.g., non-equivariant with respect to all other rotations), and the fully connected layer 225 may be equivariant with respect to reflections (e.g., non-equivariant with respect to rotations).

In some aspects, the training system may additionally or alternatively use a divergence loss between a given likelihood function 212 and a uniform distribution to encourage the likelihood functions to align with the uniform distribution. That is, the parameters of each likelihood function 212 may be learned at least in part by computing a respective divergence loss between the respective likelihood function 212 and a uniform distribution. This use of divergence loss with respect to a uniform distribution can discourage each layer from disrupting equivariance with respect to a given group element unless sufficient value or accuracy is gained by abandoning the equivariance).

As discussed above, if the input 205 exhibits symmetries with respect to an entire transformation group G at multiple scales, the likelihood functions 212 may learn similar (or identical) parameters and the model may be equivariant with respect to G. However, if the input 205 exhibits reduced symmetry, each likelihood function 212 may learn a respective reduced symmetry, substantially improving the accuracy of the generated outputs 230 (as compared to conventional approaches).

### Example Equivariance Across Group Elements for a Machine Learning Model

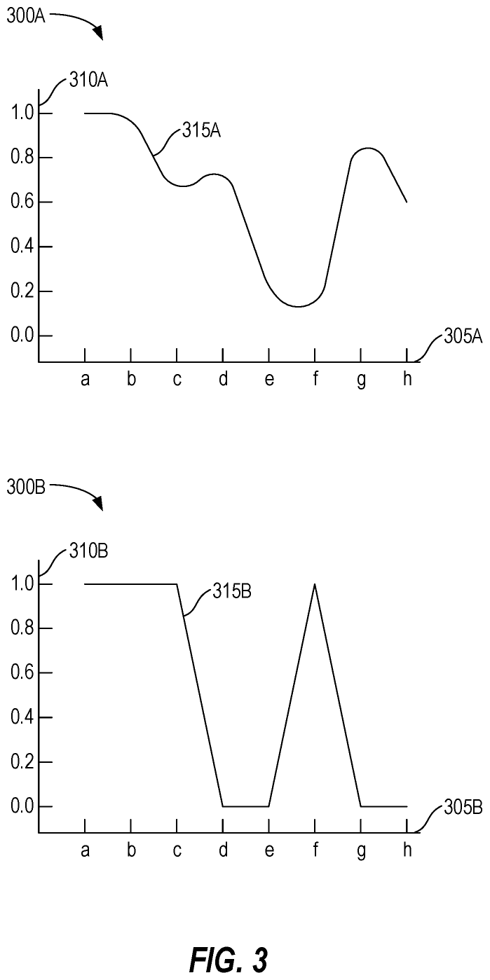

FIG. 3 depicts graphs 300A and 300B of selective equivariance across group elements for a machine learning model. In some aspects, the graphs 300 depict equivariance for a selectively equivariant machine learning model, such as the selectively equivariant machine learning model 120 of FIG. 1 and/or the architecture 200 of FIG. 2.

In the illustrated example, each of the graphs 300A and 300B (collectively, graphs 300) may depict equivariance with respect to a given layer of the model (e.g., for the convolution layer 210A of FIG. 2). In particular, each graph 300 depicts the value or output of a likelihood function with respect to each group element of a transformation group. As discussed above, the likelihood function may define equivariance (e.g., where a value of one indicates full equivariance with respect to the group element, and a value of zero indicates no equivariance with respect to the group element).

In the graph 300A, the group elements a, b, c, d, e, f, g, and h of a transformation group G are arranged on the horizontal axis 305A, and the vertical axis 310A corresponds to the value of the likelihood function for the layer. The particular value of the likelihood function for each group element is illustrated by a line 315A. In the illustrated example graph 300A, the likelihood function defines non-binary degrees of equivariance with respect to each group element. For example, for group elements a and b, the likelihood function (as indicated by the line 315A) has a value equal to or near 1, indicating that the layer is largely (or entirely) equivariant with respect to these group elements.

As illustrated by the line 315A, other group elements have varying non-binary degrees of equivariance in the layer. For example, the likelihood function has a value of approximately 0.65 for the group element c, a value of approximately 0.75 for the group element d, a value of approximately 0.2 for the group element e, a value of approximately 0.18 for the group element f, a value of approximately 0.82 for the group element g, and a value of approximately 0.6 for the group element h. Though not depicted in the illustrated example, in some aspects, the likelihood function (as indicated by the line 315A) may have a value equal to or near 0 for one or more group elements, indicating that the layer is largely (or entirely) non-equivariant with respect to such group elements.

By using such non-binary values, the machine learning model may exhibit selective or partial equivariance. That is, the model may be fully equivariant with respect to some group elements, fully non-equivariant with respect to others, and neither fully equivariant nor fully non-equivariant with respect to still other group elements.

Although the illustrated graph 300A depicts a smooth continuous (e.g., differentiable) likelihood function for conceptual clarity, in some aspects, the likelihood function may be a non-smooth (e.g., non-differentiable) curve with one or more sharp corners.

In the graph 300B, the group elements a, b, c, d, e, f, g, and h of a transformation group G are arranged on the horizontal axis 305B, and the vertical axis 310B corresponds to the value of the likelihood function for the layer. The particular value of the likelihood function for each group element is illustrated by a line 315B. In the illustrated example graph 300B, the likelihood function defines a binary degree of equivariance with respect to each group element. For example, for group elements a, b, c, and f, the likelihood function (as indicated by the line 315B) has a value of 1, indicating that the layer is equivariant with respect to these group elements. Conversely, for group elements d, e, g, and h, the likelihood function (as indicated by the line 315B) has a value equal to 0, indicating that the layer is non-equivariant with respect to these group elements.

In some aspects, the binary equivariance can be defined or determined based on non-binary likelihood functions. For example, the likelihood function may be used to generate a value (e.g., between zero and one) for each group element, and this value may be evaluated using one or more criteria to determine whether to make the model equivariant with respect to the group element (e.g., setting the value to 1) or to make the model non-equivariant with respect to the group element (e.g., setting the value to zero). As one example, the training system may round the likelihood value to the nearest integer. As another example, the training system may set likelihood values that exceed a threshold (e.g., greater than or equal to 0.3) to 1, and set other values to 0.

In some aspects, by using such binary values, the machine learning model may exhibit selective or partial equivariance. That is, the model may be fully equivariant with respect to some group elements, and fully non-equivariant with respect to others.

### Example Method for Training and Deploying Selectively Equivariant Machine Learning Models

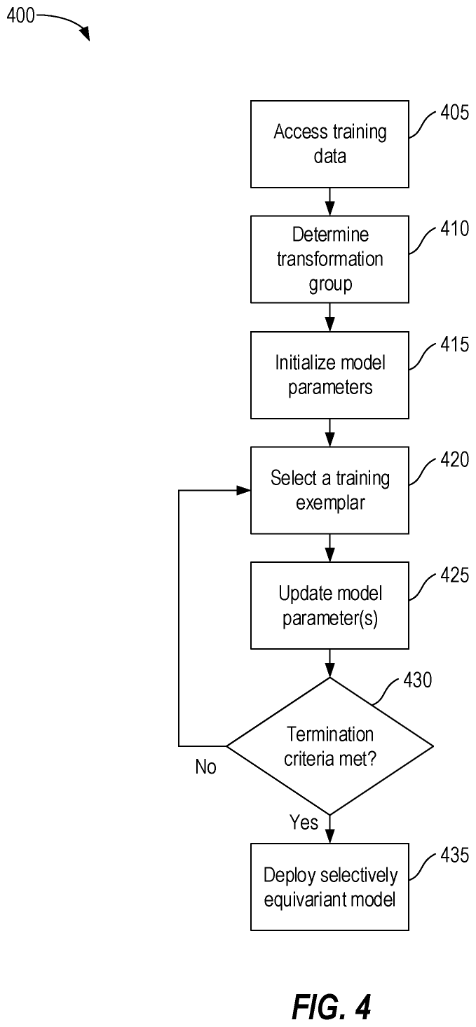

FIG. 4 is a flow diagram depicting an example method 400 for training and deploying selectively equivariant machine learning models. In some aspects, the method 400 is performed by a training system, such as the training system 115 of FIG. 1. In some aspects, the method 400 is used to train a machine learning model, such as the selectively equivariant machine learning model 120 of FIG. 1 and/or the architecture 200 of FIG. 2.

At block 405, the training system accesses a set of training data (e.g., the training data 105 of FIG. 1) to train a selectively equivariant machine learning model. As discussed above, the contents and format of the training data may vary depending on the particular implementation and task. The training data generally includes a set of exemplars, where each exemplar comprises an input (e.g., an image) and a corresponding label (e.g., indicating the proper classification of the image or objects depicted therein). For example, for object detection and recognition tasks, the input may be an image, and the label may indicate which objects are depicted in the image and/or where in the image the object is located. As another (non-limiting) example, the input may include point cloud data (e.g., LIDAR data, radar data, medical imaging data, and the like) or any other suitable input data.

As discussed above, the training data may exhibit one or more symmetries, such as rotational symmetry around one or more axes and/or by one or more amounts (e.g., symmetric with respect to rotations by 180 degrees around a given axis, but asymmetric with respect to rotation by 120 degrees along the axis), one or more reflections (e.g., symmetric with respect to reflections across one axis but asymmetric with respect to reflections across another), and the like. As discussed above, these symmetries may be unknown (or, in some cases, unknowable) due to the complexity of the data.

At block 410, the training system determines a broad transformation group (e.g., the transformation group 110 of FIG. 1) to which the model may be made equivariant. That is, the training system may determine the transformation group G consisting of group elements (e.g., transformations), where the training system can then train the model to be selectively or partially equivariant with respect to each group element. In some aspects, as discussed above, the transformation group may be defined by a user (e.g., a data scientist). In some aspects, the training system may determine or infer the transformation group (e.g., by identifying any transformations that are applicable to the type of input data). For example, the transformation group may comprise continuous rotations around one or more axes, reflections across one or more axes, and the like.

At block 415, the training system initializes the parameters of the machine learning model. For example, as discussed above, the training system may initialize some parameters (e.g., weights of convolutional and/or fully connected layers) to randomly generated values. In some aspects, as discussed above, the training system may initialize the parameters of the likelihood function(s) such that each likelihood function is a uniform distribution (e.g., having a value of 1 for each group element in the transformation group). In this way, at the beginning of training, the model will be equivariant with respect to the entire transformation group. During training, this equivariance may be disrupted based on training data.

At block 420, the training system selects a training exemplar from the accessed set of training data. Generally, the training system may use any suitable technique or operation to select the training data (including randomly or pseudo-randomly), as all of the training exemplars may be processed during the method 400.

At block 425, the training system updates the model parameters based on the selected exemplar. For example, as discussed above, the training system may process the input of the selected exemplar using the model to generate an output, and compare the output to the label of the exemplar to generate a loss (referred to in some aspects as a task loss). The training system may then refine the model parameters based on the loss (e.g., using backpropagation). As discussed above, updating the model parameters using the loss may include updating the weights of the model, as well as updating the parameters of the likelihood function (which is used to constrain the model weights, as discussed above).

In some aspects, in addition to updating the parameters of the likelihood functions using the task loss, the training system may update the parameters of the likelihood functions based further on one or more divergence losses, as discussed above. For example, the training system may generate a divergence loss for each likelihood function based on comparing the likelihood function to the likelihood function of the prior layer, and/or may generate a divergence loss for each likelihood function based on comparing the likelihood function to a uniform distribution.

In some aspects, at block 425, the training system may further constrain the updated weights based on the likelihood functions. For example, as discussed above, after generating updated (unconstrained) weights for each layer, the training system may use Equation 8 and/or Equation 14 to constrain the weights of each layer based on a corresponding learned likelihood function. As discussed above, this constraint forces each layer to exhibit partial equivariance defined by the likelihood functions.

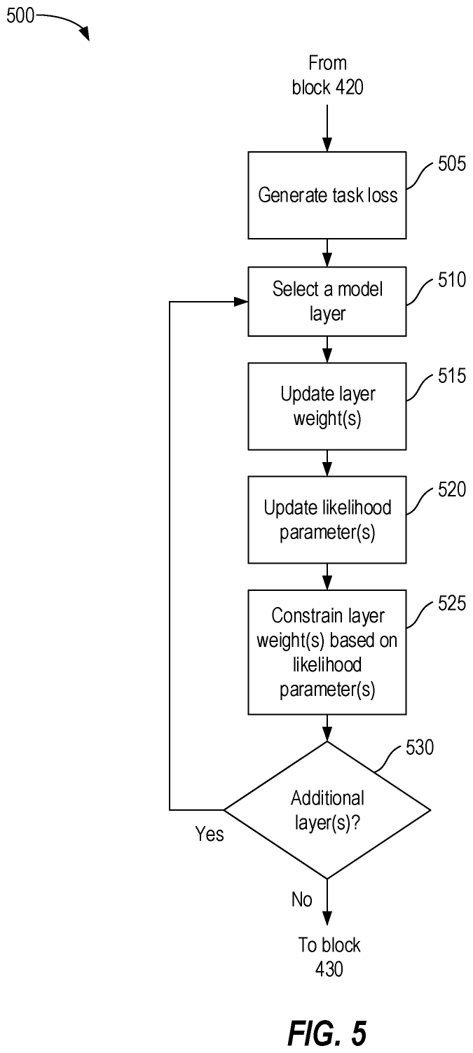

One example method for updating the model parameters at block 425 is discussed in more detail below with reference to FIG. 5. At block 430, the training system determines whether one or more termination criteria are satisfied. Generally, the termination criteria may vary depending on the particular implementation. For example, in some aspects, the training system may determine whether at least one training exemplar in the training data has not been used to update the model (in the current iteration, or at all). If so, the method 400 may return to block 420. Other example termination criteria may include determining whether a defined amount of time or resources have been spent training, whether a preferred model accuracy has been reached, and the like.

Although the illustrated example depicts an iterative process (where the training system updates the model parameters based on individual training exemplars, such as using stochastic gradient descent) for conceptual clarity, in some aspects, the training system may use a batch process (where the training system updates the model parameters based on batches of training exemplars, such as using batch gradient descent).

If, at block 430, the training system determines that the termination criteria are met, the method 400 continues to block 435, where the training system deploys the selectively equivariant model (e.g., selectively equivariant machine learning model 120 of FIG. 1) for inferencing. As discussed above, deploying the model may generally include any operations to prepare or provide the model for inferencing, such as storing the learned weights, transmitting the learned weights to one or more other systems, deploying the model for local inferencing, and the like.

### Example Method for Constraining Weights for a Selectively Equivariant Machine Learning Model

FIG. 5 is a flow diagram depicting an example method 500 for constraining weights for a selectively equivariant machine learning model. In some aspects, the method 500 is performed by a training system, such as the training system 115 of FIG. 1. In some aspects, the method 500 is used to train a machine learning model, such as the selectively equivariant machine learning model 120 of FIG. 1 and/or the architecture 200 of FIG. 2. In some aspects, the method 500 provides additional detail for block 425 of FIG. 4.

At block 505, the training system generates a task loss based on a training exemplar (e.g., the training exemplar selected at block 420 of FIG. 4). For example, as discussed above, the training system may process the input of the training exemplar using the model to generate an output (e.g., output 230 of FIG. 2). The training system may then compare the output to the label of the exemplar to generate the task loss. Generally, the particular formulation for task loss may vary depending on the particular implementation. For example, the training system may use cross-entropy loss, the mean-squared error loss, and the like.

At block 510, the training system selects a model layer (or other logical portion of the model). Generally, the training system may use any suitable technique or operation to select the layer (including randomly or pseudo-randomly), as all of the training exemplars may be processed during the method 500. In some aspects, the training system selects the layers in reverse order (e.g., beginning with the final layer and moving towards the first layer), enabling efficient backpropagation.

At block 515, the training system updates the weight(s) of the selected layer based on the task loss. For example, as discussed above, the training system may generate a set of gradients for the selected layer based on the current weights of the layer and based further on the loss (or based on the gradients from the subsequent layer, if the selected layer is not the final layer). The weights may then subsequently be updated based on these gradients, and the gradients may further be subsequently used to generate gradients for the prior layer in the model.

At block 520, the training system updates the likelihood parameters (e.g., the Fourier series coefficients of the likelihood function) based on the task loss. For example, as discussed above, the training system may similarly generate gradients for the likelihood parameters based on the task loss, and update the likelihood function based on these gradients.

In some aspects, the training system may further update the parameters of the likelihood function for the selected layer based further on one or more divergence losses, as discussed above. For example, the training system may generate a divergence loss for the selected layer by determining the difference (e.g., using KL divergence) between the likelihood function (also referred to as the likelihood distribution, as discussed above) of the selected layer (e.g., the n-th layer) and the likelihood function of the prior layer (e.g., the n−1-th layer, where the first layer of the model is the 0-th layer and the final layer is the N-th layer). As discussed above, this may encourage the likelihood function of the selected layer to be similar to the likelihood function of the prior layer (thereby encouraging the model to avoid disrupting equivariance without good reason).

As one example, the training system may generate a divergence loss for the selected layer by determining the difference (e.g., using KL divergence) between the likelihood function (also referred to as the likelihood distribution, as discussed above) of the selected layer and a uniform distribution (e.g., a distribution with a value of 1 for all group elements in the transformation group). As discussed above, this may encourage the likelihood function of the selected layer to be uniform (thereby encouraging the model to avoid disrupting equivariance without good reason).

At block 525, the training system constrains the layer weights based on the likelihood parameters. For example, using Equation 8 above (for fully connected layer) and/or Equation 14 above (for convolutional layers), the training system may constrain the weights such that the weights are selectively equivariant, as defined by the likelihood function for the layer.

Although the illustrated example depicts constraining the weights immediately after the weights are updated, in some aspects, the training system may instead constrain the weights periodically (e.g., once per iteration or epoch, where the model weights may be updated several times based on multiple exemplars prior to each application of the constraints).

Additionally, the illustrated example depicts constraining the weights based on layer-specific likelihood functions (e.g., where each respective layer learns a respective likelihood function that may differ with respect to one or more group elements). In some aspects, however, the training system may use a shared likelihood function for some (or all) of the layers in the model (e.g., such that each layer has matching equivariance).

At block 530, the training system determines whether there is at least one additional layer remaining in the model (e.g., whether the training system has updated the first or initial layer yet). If so, the method 500 returns to block 510 to select another layer (e.g., to select the prior layer for backpropagation). If all layers have been updated, the method 500 terminates.

As discussed above, although the method 500 depicts updating and constraining the layer parameters based on individual exemplars (e.g., using stochastic gradient descent), in some aspects, the training system may update the parameters based on batches of exemplars.

### Example Method for Training a Selectively Equivariant Machine Learning Model

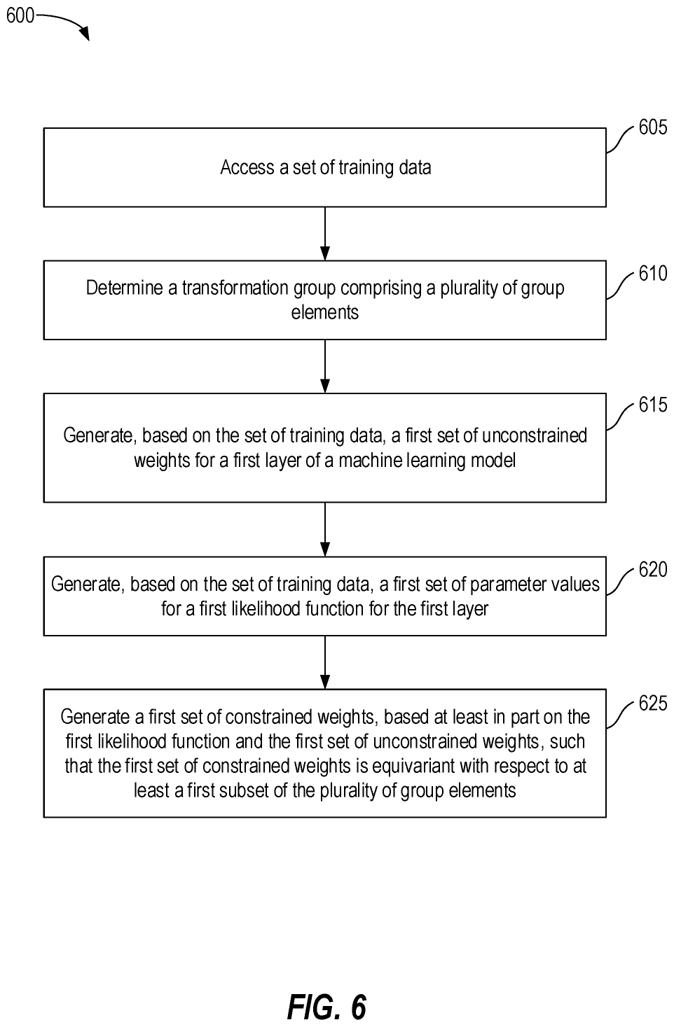

FIG. 6 is a flow diagram depicting an example method 600 for training a selectively equivariant machine learning model. In some aspects, the method 600 is performed by a training system, such as the training system 115 of FIG. 1. In some aspects, the method 600 is used to train a machine learning model, such as the selectively equivariant machine learning model 120 of FIG. 1 and/or the architecture 200 of FIG. 2. In some aspects, the method 600 provides additional detail for the method 400 of FIG. 4 and/or the method 500 of FIG. 5.

At block 605, a set of training data is accessed.

At block 610, a transformation group comprising a plurality of group elements is determined.

At block 615, a first set of unconstrained weights for a first layer of a machine learning model is generated based on the set of training data.

At block 620, a first set of parameter values for a first likelihood function for the first layer is generated based on the set of training data.

In some aspects, generating the first set of parameter values for the first likelihood function comprises computing a loss based on divergence between the first likelihood function and a uniform distribution.

In some aspects, the first set of parameter values comprises Fourier series coefficients.

In some aspects, the first likelihood function defines, for each respective group element of the plurality of group elements, a respective non-binary degree of equivariance for the first layer.

At block 625, a first set of constrained weights is generated based at least in part on the first likelihood function and the first set of unconstrained weights, such that the first set of constrained weights is equivariant with respect to at least a first subset of the plurality of group elements.

In some aspects, generating the first set of constrained weights comprises projecting the first set of unconstrained weights to the first set of constrained weights based on the first likelihood function.

In some aspects, the method 600 further includes generating a respective set of constrained weights for each respective layer of the machine learning model based on the first likelihood function.

In some aspects, the method 600 further includes generating, based on the set of training data, a second set of unconstrained weights for a second layer of the machine learning model, generating, based on the set of training data, a second set of parameter values for a second likelihood function for the second layer, and generating a second set of constrained weights, based at least in part on the second likelihood function and the second set of unconstrained weights, such that the second set of constrained weights is equivariant with respect to at least a second subset of the plurality of group elements.

In some aspects, the first and second likelihood functions differ with respect to at least one group element of the plurality of group elements.

In some aspects, generating the second set of parameter values for the second likelihood function comprises computing a loss based on divergence between the second likelihood function and the first likelihood function.

In some aspects, the method 600 further includes initializing the first set of unconstrained weights using randomly generated values and initializing the first set of parameter values such that the first likelihood function is a uniform distribution.

### Example Processing System for Selectively Equivariant Machine Learning

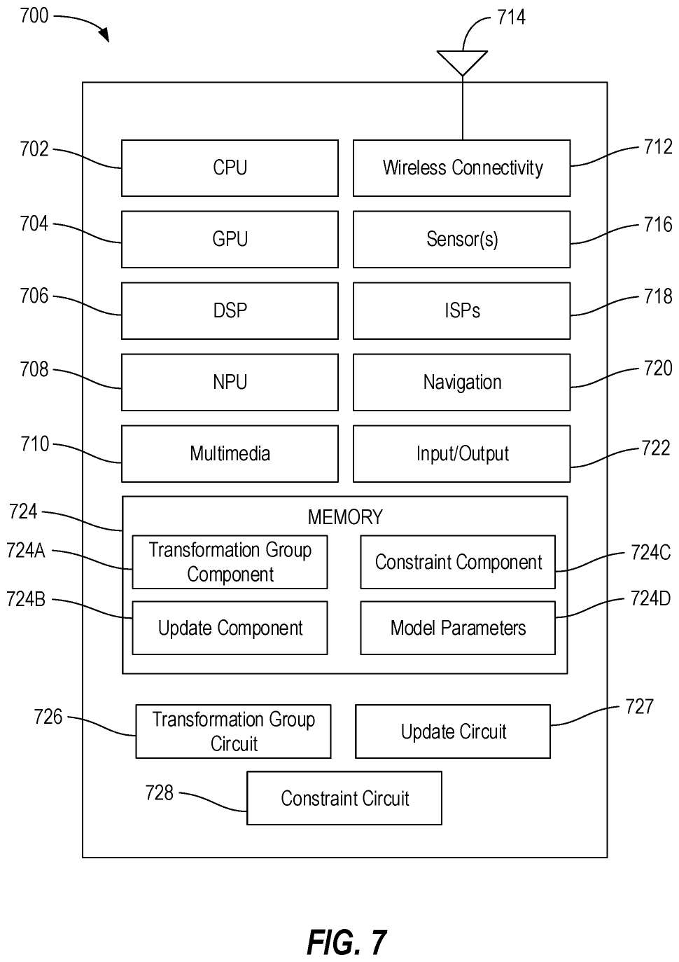

In some aspects, the workflows, techniques, and methods described with reference to FIGS. 1-6 may be implemented on one or more devices or systems. FIG. 7 depicts an example processing system 700 configured to perform various aspects of the present disclosure, including, for example, the techniques and methods described with respect to FIGS. 1-6. In some aspects, the processing system 700 may correspond to a training system, such as the training system 115 of FIG. 1. For example, the processing system 700 may correspond to a system that trains and/or constrains machine learning models to be selectively equivariant with respect to a transformation group. In some aspects, as discussed above, the processing system 700 may additionally use such selectively equivariant machine learning models to inference during runtime. Although depicted as a single system for conceptual clarity, in some aspects, as discussed above, the operations described below with respect to the processing system 700 may be distributed across any number of devices or systems.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., a partition of memory 724).

The processing system 700 also includes additional processing components tailored to specific functions, such as a graphics processing unit (GPU) 704, a digital signal processor (DSP) 706, a neural processing unit (NPU) 708, a multimedia component 710 (e.g., a multimedia processing unit), and a wireless connectivity component 712.

An NPU, such as NPU 708, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS), as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes the memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes a transformation group component 724A, an update component 724B, and a constraint component 724C. The memory 724 further includes model parameters 724D for one or more models (e.g., the selectively equivariant machine learning model 120 of FIG. 1). Although not included in the illustrated example, in some aspects the memory 724 may also include other data, such as training data (e.g., training data 105 of FIG. 1). Though depicted as discrete components for conceptual clarity in FIG. 7, the illustrated components (and others not depicted) may be collectively or individually implemented in various aspects.

The processing system 700 further comprises a transformation group circuit 726, an update circuit 727, and a constraint circuit 728. The depicted circuits, and others not depicted, may be configured to perform various aspects of the techniques described herein.

For example, the transformation group component 724A and/or the transformation group circuit 726 may be used to determine broad transformation groups (e.g., the transformation group 110 of FIG. 1) to which machine learning models may be made equivariant, as discussed above. For example, the transformation group component 724A and/or the transformation group circuit 726 may determine a set of group elements (such as rotations, reflections, and the like) to which the input data may be symmetric.

The update component 724B and/or the update circuit 727 may be used to update the model parameters (e.g., the model parameters 724D) based on training data, as discussed above. For example, the update component 724B and/or the update circuit 727 may generate task losses based on model parameters, and use the task loss to update the weight(s) of each layer of the model. In some aspects, the update may further use the task loss to update the likelihood functions that are used to define equivariance for each layer. In some aspects, the update may similarly update the likelihood functions based on divergence loss(es), as discussed above.

The constraint component 724C and/or the constraint circuit 728 may be used to constrain updated weights based on the likelihood functions, as discussed above. For example, the constraint component 724C and/or the constraint circuit 728 may use Equation 8 and/or Equation 14 to constrain the updated weights at one or more points during model training (e.g., after each update, at the end of each iteration or epoch, and the like).

Though depicted as separate components and circuits for clarity in FIG. 7, the transformation group circuit 726, the update circuit 727, and the constraint circuit 728 may collectively or individually be implemented in other processing devices of the processing system 700, such as within the CPU 702, the GPU 704, the DSP 706, the NPU 708, and the like.

Generally, the processing system 700 and/or components thereof may be configured to perform the methods described herein.

Notably, in other aspects, elements of the processing system 700 may be omitted, such as where the processing system 700 is a server computer or the like. For example, the multimedia component 710, the wireless connectivity component 712, the sensor processing units 716, the ISPs 718, and/or the navigation processor 720 may be omitted in other aspects. Further, elements of the processing system 700 may be distributed between multiple devices.

### Example Clauses

Implementation examples are described in the following numbered clauses:

Clause 1: A method, comprising: accessing a set of training data; determining a transformation group comprising a plurality of group elements; generating, based on the set of training data, a first set of unconstrained weights for a first layer of a machine learning model; generating, based on the set of training data, a first set of parameter values for a first likelihood function for the first layer; and generating a first set of constrained weights, based at least in part on the first likelihood function and the first set of unconstrained weights, such that the first set of constrained weights is equivariant with respect to at least a first subset of the plurality of group elements.

Clause 2: A method according to Clause 1, further comprising generating a respective set of constrained weights for each respective layer of the machine learning model based on the first likelihood function.

Clause 3: A method according to any of Clauses 1-2, further comprising: generating, based on the set of training data, a second set of unconstrained weights for a second layer of the machine learning model; generating, based on the set of training data, a second set of parameter values for a second likelihood function for the second layer; and generating a second set of constrained weights, based at least in part on the second likelihood function and the second set of unconstrained weights, such that the second set of constrained weights is equivariant with respect to at least a second subset of the plurality of group elements.

Clause 4: A method according to Clause 3, wherein the first and second likelihood functions differ with respect to at least one group element of the plurality of group elements.

Clause 5: A method according to any of Clauses 3-4, wherein generating the second set of parameter values for the second likelihood function comprises computing a loss based on divergence between the second likelihood function and the first likelihood function.

Clause 6: A method according to any of Clauses 1-5, wherein generating the first set of parameter values for the first likelihood function comprises computing a loss based on divergence between the first likelihood function and a uniform distribution.

Clause 7: A method according to any of Clauses 1-6, wherein generating the first set of constrained weights comprises projecting the first set of unconstrained weights to the first set of constrained weights based on the first likelihood function.

Clause 8: A method according to any of Clauses 1-7, wherein the first set of parameter values comprise Fourier series coefficients.

Clause 9: A method according to any of Clauses 1-8, further comprising: initializing the first set of unconstrained weights using randomly generated values; and initializing the first set of parameter values such that the first likelihood function is a uniform distribution.

Clause 10: A method according to any of Clauses 1-9, wherein the first likelihood function defines, for each respective group element of the plurality of group elements, a respective non-binary degree of equivariance for the first layer.

Clause 11: A processing system comprising: a memory comprising computer-executable instructions; and one or more processors configured to execute the computer-executable instructions and cause the processing system to perform a method in accordance with any of Clauses 1-10.

Clause 12: A processing system comprising means for performing a method in accordance with any of Clauses 1-10.

Clause 13: A non-transitory computer-readable medium comprising computer-executable instructions that, when executed by one or more processors of a processing system, cause the processing system to perform a method in accordance with any of Clauses 1-10.

Clause 14: A non-transitory computer-readable medium encoding logic that, when executed by a processing system, causes the processing system to perform a method in accordance with any of Clauses 1-10.

Clause 15: An apparatus comprising logic circuitry configured to perform a method in accordance with any of Clauses 1-10.

Clause 16: A computer program product embodied on a computer-readable storage medium comprising code for performing a method in accordance with any of Clauses 1-10.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
a memory comprising processor-executable instructions; and
one or more processors configured to execute the processor-executable instructions and cause the processing system to:
access a set of training data;
determine a transformation group comprising a plurality of group elements;
generate, based on the set of training data, a first set of unconstrained weights for a first layer of a machine learning model;
generate, based on the set of training data, a first set of parameter values for a first likelihood function for the first layer; and
generate a first set of constrained weights, based at least in part on the first likelihood function and the first set of unconstrained weights, such that the first set of constrained weights is equivariant with respect to at least a first subset of the plurality of group elements.

2. The processing system of claim 1, wherein the one or more processors are configured to further execute the processor-executable instructions to cause the processing system to generate a respective set of constrained weights for each respective layer of the machine learning model based on the first likelihood function.

3. The processing system of claim 1, wherein the one or more processors are configured to further execute the processor-executable instructions to cause the processing system to:
generate, based on the set of training data, a second set of unconstrained weights for a second layer of the machine learning model;
generate, based on the set of training data, a second set of parameter values for a second likelihood function for the second layer; and
generate a second set of constrained weights, based at least in part on the second likelihood function and the second set of unconstrained weights, such that the second set of constrained weights is equivariant with respect to at least a second subset of the plurality of group elements.

4. The processing system of claim 3, wherein the first and second likelihood functions differ with respect to at least one group element of the plurality of group elements.

5. The processing system of claim 3, wherein, to generate the second set of parameter values for the second likelihood function, the one or more processors are configured to execute the processor-executable instructions to cause the processing system to compute a loss based on divergence between the second likelihood function and the first likelihood function.

6. The processing system of claim 1, wherein, to generate the first set of parameter values for the first likelihood function, the one or more processors are configured to execute the processor-executable instructions to cause the processing system to compute a loss based on divergence between the first likelihood function and a uniform distribution.

7. The processing system of claim 1, wherein, to generate the first set of constrained weights, the one or more processors are configured to execute the processor-executable instructions to cause the processing system to project the first set of unconstrained weights to the first set of constrained weights based on the first likelihood function.

8. The processing system of claim 1, wherein the first set of parameter values comprises Fourier series coefficients.

9. The processing system of claim 1, wherein the one or more processors are configured to further execute the processor-executable instructions to cause the processing system to:
initialize the first set of unconstrained weights using randomly generated values; and
initialize the first set of parameter values such that the first likelihood function is a uniform distribution.

10. The processing system of claim 1, wherein the first likelihood function defines, for each respective group element of the plurality of group elements, a respective non-binary degree of equivariance for the first layer.

11. One or more non-transitory computer-readable media comprising computer-executable instructions that, when executed by one or more processors of a processing system, cause the processing system to:
access a set of training data;
determine a transformation group comprising a plurality of group elements;
generate, based on the set of training data, a first set of unconstrained weights for a first layer of a machine learning model;
generate, based on the set of training data, a first set of parameter values for a first likelihood function for the first layer; and
generate a first set of constrained weights, based at least in part on the first likelihood function and the first set of unconstrained weights, such that the first set of constrained weights is equivariant with respect to at least a first subset of the plurality of group elements.

12. The one or more non-transitory computer-readable media of claim 11, wherein the computer-executable instructions further cause the processing system to generate a respective set of constrained weights for each respective layer of the machine learning model based on the first likelihood function.

13. The one or more non-transitory computer-readable media of claim 11, wherein the computer-executable instructions further cause the processing system to:
generate, based on the set of training data, a second set of unconstrained weights for a second layer of the machine learning model;
generate, based on the set of training data, a second set of parameter values for a second likelihood function for the second layer; and
generate a second set of constrained weights, based at least in part on the second likelihood function and the second set of unconstrained weights, such that the second set of constrained weights is equivariant with respect to at least a second subset of the plurality of group elements.

14. The one or more non-transitory computer-readable media of claim 13, wherein the first and second likelihood functions differ with respect to at least one group element of the plurality of group elements.

15. The one or more non-transitory computer-readable media of claim 13, wherein, to generate the second set of parameter values for the second likelihood function, the computer-executable instructions cause the processing system to compute a loss based on divergence between the second likelihood function and the first likelihood function.

16. The one or more non-transitory computer-readable media of claim 11, wherein, to generate the first set of parameter values for the first likelihood function, the computer-executable instructions cause the processing system to compute a loss based on divergence between the first likelihood function and a uniform distribution.

17. The one or more non-transitory computer-readable media of claim 11, wherein, to generate the first set of constrained weights, the computer-executable instructions cause the processing system to project the first set of unconstrained weights to the first set of constrained weights based on the first likelihood function.

18. The one or more non-transitory computer-readable media of claim 11, wherein the first set of parameter values comprises Fourier series coefficients.

19. The one or more non-transitory computer-readable media of claim 11, wherein the computer-executable instructions further cause the processing system to:
initialize the first set of unconstrained weights using randomly generated values; and
initialize the first set of parameter values such that the first likelihood function is a uniform distribution.

20. The one or more non-transitory computer-readable media of claim 11, wherein the first likelihood function defines, for each respective group element of the plurality of group elements, a respective non-binary degree of equivariance for the first layer.

21. A processor-implemented method, comprising:
accessing a set of training data;
determining a transformation group comprising a plurality of group elements;
generating, based on the set of training data, a first set of unconstrained weights for a first layer of a machine learning model;
generating, based on the set of training data, a first set of parameter values for a first likelihood function for the first layer; and
generating a first set of constrained weights, based at least in part on the first likelihood function and the first set of unconstrained weights, such that the first set of constrained weights is equivariant with respect to at least a first subset of the plurality of group elements.

22. The processor-implemented method of claim 21, further comprising generating a respective set of constrained weights for each respective layer of the machine learning model based on the first likelihood function.

23. The processor-implemented method of claim 21, further comprising:
generating, based on the set of training data, a second set of unconstrained weights for a second layer of the machine learning model;
generating, based on the set of training data, a second set of parameter values for a second likelihood function for the second layer; and
generating a second set of constrained weights, based at least in part on the second likelihood function and the second set of unconstrained weights, such that the second set of constrained weights is equivariant with respect to at least a second subset of the plurality of group elements.

24. The processor-implemented method of claim 23, wherein the first and second likelihood functions differ with respect to at least one group element of the plurality of group elements.

25. The processor-implemented method of claim 23, wherein generating the second set of parameter values for the second likelihood function comprises computing a loss based on divergence between the second likelihood function and the first likelihood function.

26. The processor-implemented method of claim 21, wherein generating the first set of parameter values for the first likelihood function comprises computing a loss based on divergence between the first likelihood function and a uniform distribution.

27. The processor-implemented method of claim 21, wherein generating the first set of constrained weights comprises projecting the first set of unconstrained weights to the first set of constrained weights based on the first likelihood function.

28. The processor-implemented method of claim 21, further comprising:
initializing the first set of unconstrained weights using randomly generated values; and
initializing the first set of parameter values such that the first likelihood function is a uniform distribution.

29. The processor-implemented method of claim 21, wherein the first likelihood function defines, for each respective group element of the plurality of group elements, a respective non-binary degree of equivariance for the first layer.

30. A processing system, comprising:
means for accessing a set of training data;
means for determining a transformation group comprising a plurality of group elements;
means for generating, based on the set of training data, a set of unconstrained weights for a layer of a machine learning model;
means for generating, based on the set of training data, a set of parameter values for a likelihood function for the layer of the machine learning model; and
means for generating a set of constrained weights, based at least in part on the likelihood function and the set of unconstrained weights, such that the set of constrained weights is equivariant with respect to at least a subset of the plurality of group elements.
